(19) United States
(12) Patent Application Publication
(10) Pub. No.: US 2016/0249106 A1
(43) Pub. Date: Aug. 25, 2016

(54) Remote Control of a Mobile Device

(71) Applicants: Manish LACHWANI, Sunnyvale, CA (US); Jay SRINIVASAN, San Francisco, CA (US); Rahul JAIN, San Francisco, CA (US); Pratyus PATNAIK, San Francisco, CA (US)

(72) Inventors: Manish LACHWANI, Sunnyvale, CA (US); Jay SRINIVASAN, San Francisco, CA (US); Rahul JAIN, San Francisco, CA (US); Pratyus PATNAIK, San Francisco, CA (US)

(73) Assignee: Appurify, Inc., San Francisco, CA (US)

(21) Appl. No.: 13/619,867

(22) Filed: Sep. 14, 2012

(51) Int. Cl. H04N 21/482; H04N 7/26; H04N 21/422; H04N 21/478; H04N 21/2343

(52) U.S. Cl. CPC H04N 21/482; H04N 21/234363; H04N 21/42222; H04N 21/478

(57) ABSTRACT

A remote control module enables remote operation and control of a host device such as a mobile computing device. The user may employ an interface of the service to specify input events to be executed on the host device, such as touch, text, numeric, key, voice, haptic, or other types of inputs. The input events may be executed on the device through a virtualization module executing as a background process on the device. A display capture module may also execute as a background process on the host device to capture screenshots of the host device display using a hardware video encoder of the host device. The screenshots are placed in device memory. The remote control module may retrieve the screenshots from the host device memory, assemble them into a video stream, and provide the video stream to the user through the user interface as a real-time view of the host device.

### BACKGROUND

The increasing popularity of mobile computing devices, such as smartphones, tablet computers, electronic book (eBook) readers, and so forth, has led to a proliferation of applications, or apps, to run on such devices. To ensure high quality and to identify problems, many app developers test their apps before launching them to the public. However, app testing may be time- and resource-intensive, particularly in cases where the app is to be tested on many different mobile devices running a variety of mobile operating systems of various versions under various use conditions.

### BRIEF DESCRIPTION OF THE FIGURES

FIG. 1 depicts an environment in which remote control of one or more host devices is provided.

FIG. 2 depicts a block diagram of a remote control server device configured to couple to, and provide remote control of, the host device.

FIG. 3 depicts a block diagram of the host device that may be coupled to the remote control server for remote control.

FIG. 4 depicts a user interface to enable a user to remotely control a device and view information captured from the host device, as described herein.

FIG. 5 depicts a flow diagram of a process for remotely controlling a device, according to embodiments.

FIG. 6 depicts a flow diagram of a process for providing input to the host device and receiving screenshot data from the host device which may be provided as a video stream to the client device.

FIG. 7 depicts a flow diagram of a process for remotely controlling the host device.

FIG. 8 depicts an environment in which remote control of one or more host devices is provided.

FIG. 9 depicts a flow diagram of a process for adjusting the video stream from the host device.

Certain implementations and embodiments will now be described more fully below with reference to the accompanying figures, in which various aspects are shown. However, various aspects may be implemented in many different forms and should not be construed as limited to the implementations set forth herein. Like numbers refer to like elements throughout.

### DETAILED DESCRIPTION

### Overview

Described in disclosure are embodiments of systems and methods to enable the remote operation and control of a computing device. This remote operation and control may be used to provide for application (“app”) testing on the device, training in the use of the device, and so forth. A remote control server provides a remote control module to enable a user to remotely control a host device. The remote control module may include a user interface (e.g., a web interface), and the user may log in to the user interface to remotely control the host device. Through the user interface, the user may specify input events to be executed on the host device, the input events including but not limited to one or more of touch inputs (e.g., taps, swipes, or other gestures), text inputs, numeric inputs, key inputs on a dedicated button or key, voice or audio inputs, or haptic inputs.

The input events may be executed on the host device through a virtualization module executing on the host device. While the user is thus remotely manipulating the host device, a display capture module may execute on the host device to capture screenshots of the host device display. In some embodiments, the display capture module may employ a hardware video encoder of the host device to capture the screenshots. Each screenshot may be stored (e.g., individually, one at a time) on local storage of the host device. The remote control module may then retrieve the screenshots from the local storage of the host device, assemble them into a video stream, and provide the video stream to the user through the user interface. In this way, embodiments enable the user to view, in real time, the results of the various input events executed on the host device by the virtualization module.

In some embodiments, the remote control module may monitor the network connection to the user's client device, and adjust a resolution of the video stream or transfer of other data according to the available throughput of the network connection. Moreover, in some embodiments, the web interface may provide functionality for the user to specify one or more environment settings to the host device. The environment settings may include one or more of a date or time for the host device, designate a location for the host device, specify a processor or memory load to place on the host device, set various network connection conditions for the host device, and so forth. Such environment settings may allow a user to test apps on the host device under various combinations of environmental and usage conditions.

A performance/debug data capture module may also execute on the host device while it is under remote control to collect performance data and/or code-level debug data for apps or other processes executing on the host device. Such performance and/or debug data may be presented to the user through the user interface. Various embodiments are described in further detail below with reference to the figures.

### Illustrative Environment

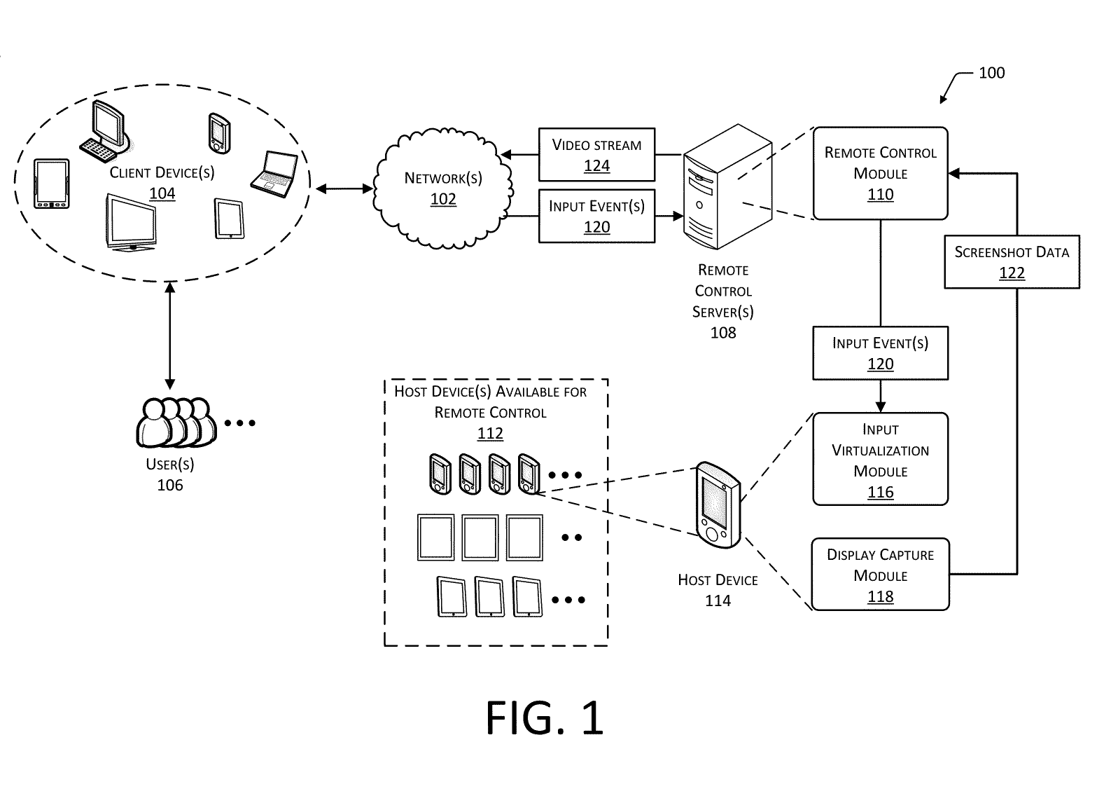

FIG. 1 shows an example environment 100 in which various embodiments of remote control of one or more host devices may operate. In embodiments, the various devices and/or modules of environment 100 may communicate with one another and with external devices via one or more networks 102. Such networks may include public networks such as the Internet, private networks such as an institutional and/or personal intranet, or some combination of private and public networks. The networks may also include any type of wired and/or wireless network, including but not limited to local area networks (LANs), wide area networks (WANs), Wi-Fi, WiMax, and mobile communications networks (e.g. 3G, 4G, and so forth). The networks may utilize communications protocols, including packet-based and/or datagram-based protocols such as internet protocol (IP), transmission control protocol (TCP), user datagram protocol (UDP), or other types of protocols.

In some embodiments, the environment 100 includes one or more client devices 104 that are owned by, operated by, and/or otherwise associated with one or more users 106. The client devices 104 may include any type of computing device that is able to communicate with other devices over a network, including but not limited to desktop computers, personal computers, laptop computers, tablet computers, electronic book readers, wearable computers, implanted computers, mobile phones, thin clients, terminals, game consoles, mobile gaming devices, and the like. In some embodiments, the client devices 104 include one or more applications that provide a user interface to connect with a remotely hosted service. For example, the client devices 104 may run a web browser to enable user(s) 106 to view and interface with a web site. Embodiments support the use of various web browsers including, but not limited to, Mozilla® Firefox®, Microsoft® Internet Explorer®, Google® Chrome®, Apple® Safari®, Rockmelt®, and other browsers. In some embodiments the user 106 may communicate with a remote service via some other type of application, or through a dedicated client-side application.

In some embodiments, environment 100 includes one or more server computing devices. Such servers may include any type of computing device including, but not limited to, network servers, rack-mounted servers, workstations, desktop computers, laptop computers, tablet computers, mobile computing devices, virtual servers, cloud resources, and the like. Further, the servers shown may include one or more computing devices that operate in a cluster or other grouped configuration to share resources, balance load, increase performance, provide fail-over support or redundancy, or for other purposes. The servers may also include one or more hardware modules and/or one or more software modules (e.g., processes and/or applications) to perform tasks as described herein.

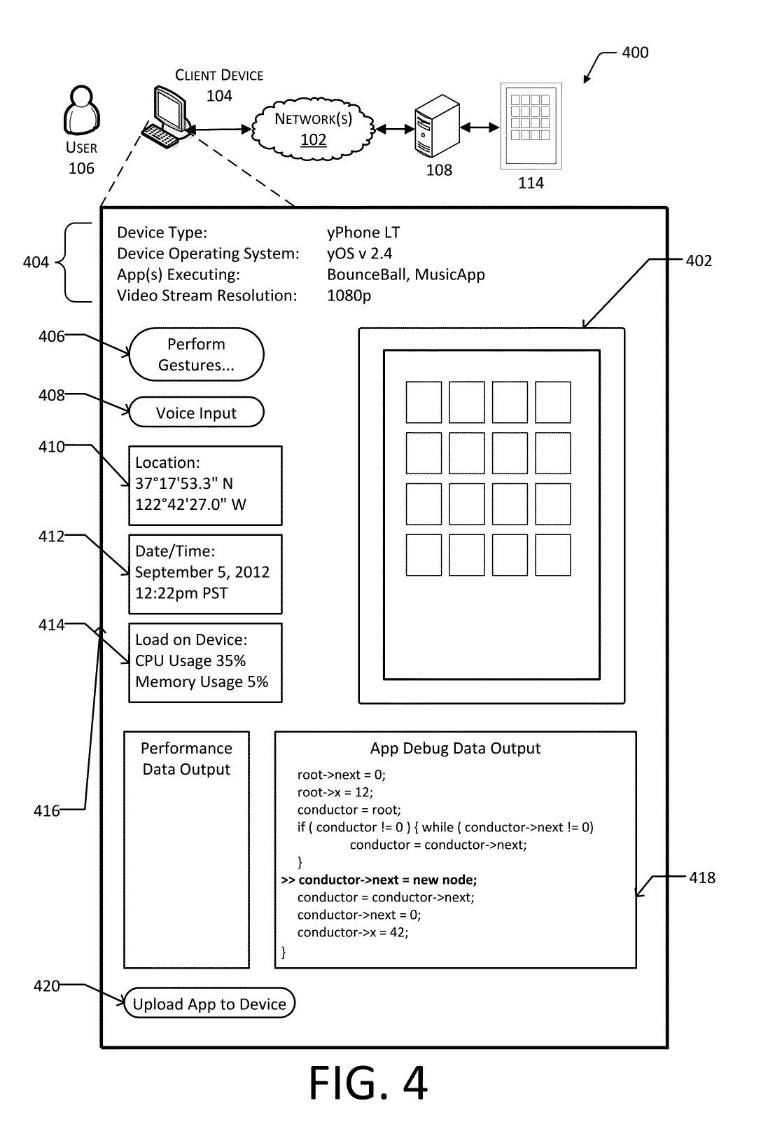

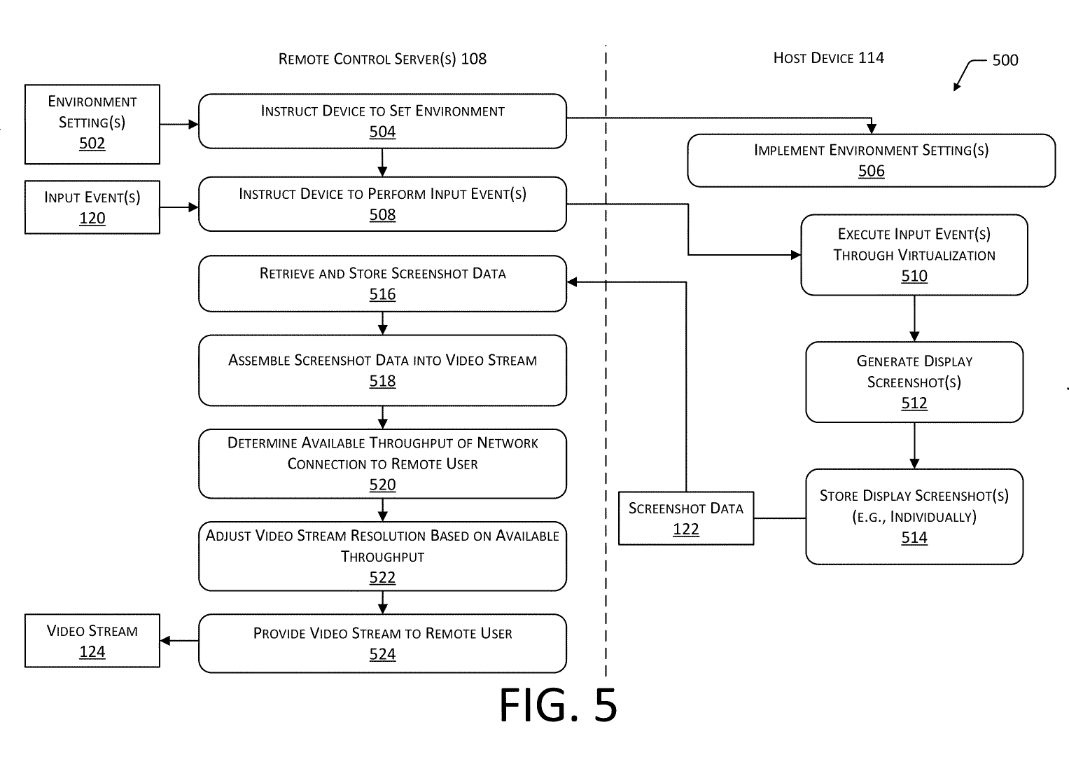

As shown in FIG. 1, the environment 100 includes one or more remote control servers 108. In some embodiments, the remote control server(s) 108 run one or more software modules, processes, and/or applications that comprise a remote control module 110. The remote control module 110 may provide a web interface that is accessible to the user 106 through a web browser executing on the client devices 104, the web interface enabling a user to remotely control a device. An example web interface for the service is described with regard to FIG. 4, and the operations of the remote control module 110 are further described with regard to FIG. 5.

The environment 100 may also include a group of host device available for remote control 112. This group may include an array of different types of computing devices, operating systems, software, firmware, and so forth. In some embodiments, host devices available for remote control 112 include mobile computing devices such as smartphones, tablets, eBook readers, wearable computers, automotive computers, and the like. However, embodiments are not so limited, and embodiments may support any type of host device for remote control. In some embodiments, host devices available for remote control 112 include devices that incorporate one or more displays.

In some embodiments, the remote control module 110 may include functionality that enables the user 106 to remotely control one of the array of devices available for remote control 112, for example a host device 114. In some embodiments, the host devices 114 have had various software modules installed, such as an input virtualization module 116 and a display capture module 118. Such modules may be stored in the host device memory and executed by the host device's processor to perform actions according to embodiments.

In some cases, the host devices 114 available for remote control 112 have been modified to enable additional software to be installed on the host devices 114, enable system-level or other data to be downloaded from the host devices 114, and so forth. Such modifications may include removing various manufacturer-imposed limitations on software installation to the host device 114 or data retrieval from the host device 114, and/or gaining root access to the host device 114. Such modifications are performed in a manner that minimizes their impact on executing apps, providing for a test environment substantially similar to that in which an app would run under normal, end-user usage conditions. In some embodiments, the impact of modification of the host device 114 (e.g., software modifications and installation of modules 116 and 118) is such that the modifications consume no more than 20% of processing capacity of the host device 114, and in some bases less than 15% of the processing capacity. Furthermore, using the techniques described in this disclosure, memory consumption for the input virtualization module 116 and the display capture module 118 may be less than 20 megabytes of the memory resources in the host device 114.

In some embodiments, the input virtualization module 116 executes as a background process on the host device 114, and receives one or more input events 120. The input events 120 may be requested by the user 106 through the web interface of the remote control module 110, and the remote control module 110 may then transmit the input events 120 to the input virtualization module 116 executing on the host device 114. The input events 120 may be executed by the input virtualization module 116, to produce the substantially same effect on the host device 114 as if the events were directly input by a locally present user of the host device 114. Embodiments support any type of input virtualization module 116 to execute input events 120 on the host device 114.

In some embodiments, the input virtualization module 116 may be at least a portion of the Virtual Network Computing® (VNC) server. Because VNC is designed for virtualization of a desktop computer, running the full VNC server on a mobile device under remote control may consume 60-70% of the host device's processing capacity and render the host device nearly unusable for running other processes. Accordingly, some embodiments in this disclosure employ a portion of the VNC server executing on the host device 114. The portion of the VNC server executing may be those modules of VNC that enable virtual execution of input events on the host device 114, but not those modules that provide display images back to the user 106. Virtual execution is the process of executing on the host device 114 an input which is physically manifested or selected at another location. Actual execution of the user command comprises selecting a user interface element in the user interface on the client device 104. In comparison, the virtual execution comprises receiving data indicative of the actual execution and performing the action on the host device 114 as if the user 106 was physically present at the host device 114.

In some embodiments, the input virtualization module 116 may receive input events 120 at a particular port on host device 114. In some cases, a reduced version of the VNC server running on the host device 114 may be further modified to enable it to run on an operating system of the host device 114 and remove the functionality that enables the VNC server to communicate with a dedicated VNC client. The operating system of the host device 114 may comprise a mobile operating system, configured to execute in a processor- and memory-constrained environment.

In some embodiments, while the input virtualization module 116 is virtually executing input events 120 specified by the user 106, a display capture module 118 is executed on the host device 114. The display capture module 118 may be executed as a background process. In some embodiments, the display capture module 118 uses a hardware-based video encoder (e.g., a H.264 encoder) on the host device 114 to capture screenshots of one or more displays on the host device's 114. Such screenshots may be saved individually in the host device's memory, one at a time, such that each screenshot overwrites the previously captured and stored screenshot in memory. The remote control module 110 may retrieve the stored screenshot data 122 from the host device 114. Once retrieved, the screenshots may be stored on the remote control server(s) 108.

Having retrieved the screenshots, the remote control module 110 may assemble the screenshots into a video stream 124 which is then streamed to the web interface for the user 106. In this way, user 106 may be provided with a real-time view of the display of the host device 114. In some embodiments, the display capture module 118 is a web server executing on the host device 114, and making the captured screenshots available for retrieval by the remote control module 110 at a particular uniform resource locator (URL) and port for the host device 114. The display capture module 118 may include a web server with a small memory footprint, consumes a minimal amount of processor resources, or both on the host device 114. For example, the web server may include functionality to provide a plurality of screenshots as a video stream of screenshot data 122 over a particular port (e.g., port 80) while other functionality such as server-side scripting, virtual hosting, and so forth is omitted. In some embodiments, access to the screenshots stored by the display capture module 118 (e.g., web server) is restricted such that the remote control module 110 may access it, but other external users or processes may not access the web server on the host device 114.

The screenshots may be captured at the full native refresh or redraw rate of the display on the host device 114 and at full resolution presented on the display. The host device 114 may support H.264 encoding of MPEG-4 at a hardware level, such as with a hardware-based video encoder. The hardware-based video encoder may be on a same die as a processor of the host device 114, or on an external die which is in the host device 114.

Using the hardware-based video encoder to generate the screenshot data 122, the video stream 124 assembled at the remote control server(s) 108 from the screenshots may thus be representative of the full refresh or redraw rate and the full resolution of the one or more displays in the host device 114. The plurality of screenshots may be encoded at a frame rate of at least fifty frames per second and a resolution of at least three-hundred thousand pixels per frame. For example, high resolution images of 480 p video of 60 frames per second at 640 by 480 pixels, 720 p video of 60 frames per second at 1280 by 720 pixels, or 1080 p video of 60 frames per second at 1920 by 1080 pixels may be captured.

Because the H.264 encoder may be continuously taking screenshots of the host device display the screenshot data exiting the host device may be of a high resolution which provides a high-fidelity representation of the image presented on the display of the host device 114. A screenshot frequency at which the screenshots are acquired may be synchronized to the refresh rate or redraw of the display. For example, a liquid crystal display with a refresh rate of 60 frames per second would result in the screenshot frequency of 60 screenshots per second.

For example, the display of the host device 114 may have a resolution of 2,048×1,536 pixels which is 3145728 bytes or 3.14 megabytes (MB) (i.e., approximately 25 megabits (Mb)) of data in any given frame. To support such large amounts of video to be transferred, embodiments may employ an electrical or optical connection. In one embodiment, a universal serial bus (USB) 2.0 or better connection may be used to communicatively couple the host device 114 to the remote control server 108. The USB connection may be used to transfer the screenshot data 122 from the host device 114 to the remote control servers 108, using TCP as a communication protocol. The USB 2.0 connection may support high speed data rates exceeding 400 Mb/sec and up to 480 Mb/sec, enabling a video stream 124 of the host device 114 display to be provided to the user 106 which is a high-fidelity representation of the images presented on the host device 114. Other implementations of USB, such as USB 3.0 and beyond may also be used. In other implementations other connections may be used, including but not limited to high-definition multimedia interface (HDMI), IEEE 1394, Ethernet, eSATA, and so forth.

In some cases, the user 106 may be using a web browser at a remote location to view the video stream 124 from remote control server(s) 108, and may have a network connection with available throughput that is low, such that it may not be able to accommodate 25-30 Mb/sec of data. Given that, in some embodiments the remote control module 110 monitors the available throughput of the user's connection and adjusts the resolution of the output video stream 124 accordingly. For example, the remote control module 110 may include an intermediate video encoder/decoder that downsamples the screenshot data 122 from the high resolution 1080 p stream by decoding it and then re-encoding it as the video stream 124 with a lower resolution depending on the available throughput of the connection (e.g., re-encode it to a 360 p resolution and/or alter the format to a MPEG-2 stream). In other implementations, a transcoding module may be used to convert the screenshot data 122 retrieved from the host device 114 to another format suitable for presentation on the client device 104.

### Illustrative Computing Systems

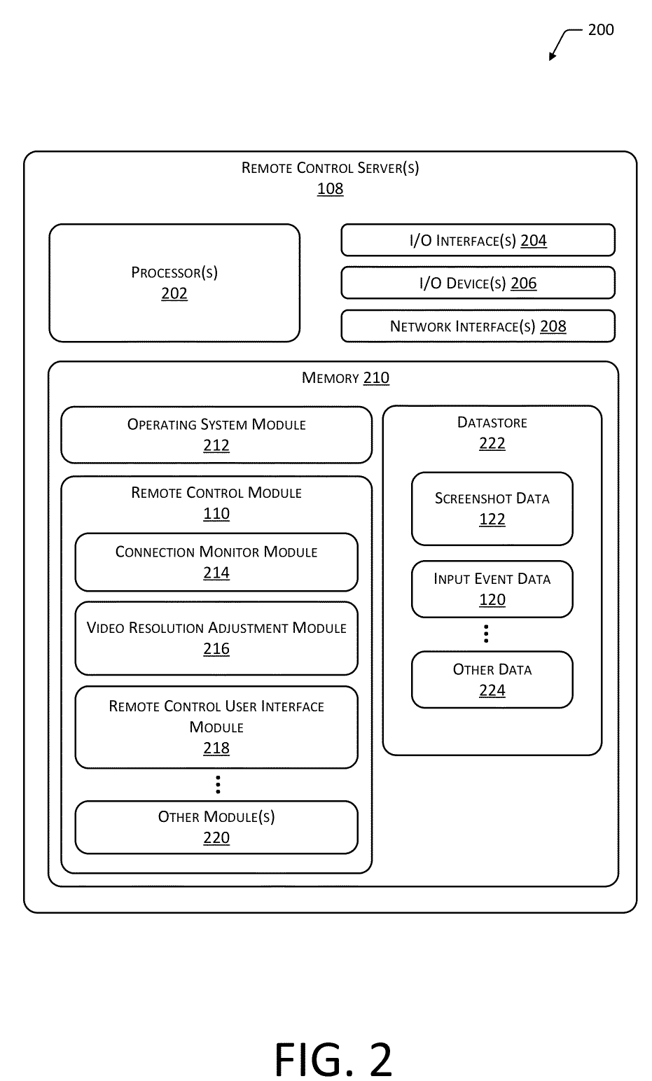

FIG. 2 depicts a block diagram 200 of the remote control server 108 that may be used to implement various embodiments described herein. The remote control server 108 may include one or more processors 202 configured to execute one or more stored instructions. The processors 202 may comprise one or more cores.

The remote control server 108 may include one or more input/output (I/O) interface(s) 204 to allow the remote control server 108 to communicate with other devices. The I/O interface 204 may be configured to provide a universal serial bus (USB) connection compliant with the standards promulgated by the USB Implementers Forum, Inc. of Beaverton, Oreg.

The I/O interface 204 may couple to one or more I/O devices 206. The I/O devices 206 may include user input devices such as one or more of a keyboard, a mouse, a pen, a game controller, a voice input device, a touch input device, gestural input device, one or more host devices 114, and so forth. The I/O devices 206 may include output devices such as one or more of a display, a printer, audio speakers, haptic output device, and so forth. In some embodiments, the I/O devices 206 may be physically incorporated with the remote control server 108 or be externally placed.

The remote control server 108 may also include one or more network interfaces 208 to enable communications between the remote control server 108 and other networked devices such as those depicted in FIG. 1. Such network interfaces 208 may include one or more network interface controllers (NICs) or other types of transceiver devices configured to send and receive communications over the one or more networks 102. The remote control server 108 may also include one or more busses or other internal communications hardware or software that allow for the transfer of data between the various modules and components of remote control server 108.

As shown in FIG. 2, the remote control server 108 includes one or more memories 210. The memory 210 comprises one or more computer-readable storage media (“CRSM”). The CRSM may be any one or more of an electronic storage medium, a magnetic storage medium, an optical storage medium, a quantum storage medium, a mechanical computer storage medium, and so forth. The memory 210 provides storage of computer readable instructions, data structures, program modules, and other data for the operation of the remote control server 108.

The memory 210 may include at least one operating system (OS) module 212. The operating system module 212 is configured to manage hardware resources such as the I/O interfaces 204 and provide various services to applications or modules executing on the one or more processors 202.

In some embodiments, the OS 212 may comprise a distribution or variant of the Linux® operating system originally released by Linus Torvalds. In the example shown, the memory 210 includes the remote control module 110 to perform actions for embodiments described herein. The remote control module 110 may include a connection monitor module 214, a video resolution adjustment module 216, and a remote control user interface module 218.

The connection monitor module 214 is configured to monitor the network connection between the remote control server 108 and the user's 106 client device 104. The connection monitor module 214 may determine available throughput along one or more network paths through the network 102 to the client device 104 of the user 106. The connection monitor module 214 may be configured to assess quality of service, latency, available bandwidth, and so forth. In one implementation the connection monitor module 214 may work in conjunction with a complementary module or script executing on the client device 104. For example, the complementary module may return data to the remote control server 108 indicating data loss or latency of packets received from the remote control server 108.

The video resolution adjustment module 216 is configured to adjust the resolution or encoding of the output video stream 124 based at least in part on the available throughput of the network connection. For example, during periods where the available throughput on the network 102 is reduced, the screenshot data 122 may be downsampled to provide an output video stream 124 which requires less bandwidth to deliver. Downsampling may then be discontinued as network 102 conditions improve.

The remote control module 110 may also include a remote control user interface module 218. The remote control user interface module 218 may be configured to provide an application programming interface, web interface, or other facility to allow the client device 104 to communicate with the remote control module 110. The remote control user interface module 218 enables the user to provide input and receive output associated with the host device 104 and the host device's 104 operation. The remote control user interface module 218 may accept input events, environment settings, and so forth for the host device 114 and present a view of the output video stream 124 representative of what is being displayed on the host device 114 display. The remote control user interface module 218 is described further with reference to the example interface shown in FIG. 4 below. Operation of the remote control module 110 is described in further detail with reference to FIG. 5 below.

Other modules 220 may also be included in the remote control servers 108. These other modules 220 may include, but are not limited to, user authentication modules, access control modules, billing modules, and so forth.

In some embodiments, the memory 210 also includes a datastore 222 to store information for operations of remote control server 108. The datastore 222 may comprise a database, array, structured list, tree, or other data structure. The datastore 222 may store the screenshot data 122 retrieved from the host device 114, the input event data 120 received from the user 106 via the remote control user interface module 218, or both. Other data 224 may also be stored in the datastore 222, such as user account information, different device images for loading onto the host device 114, test scripts, debugging results, and so forth.

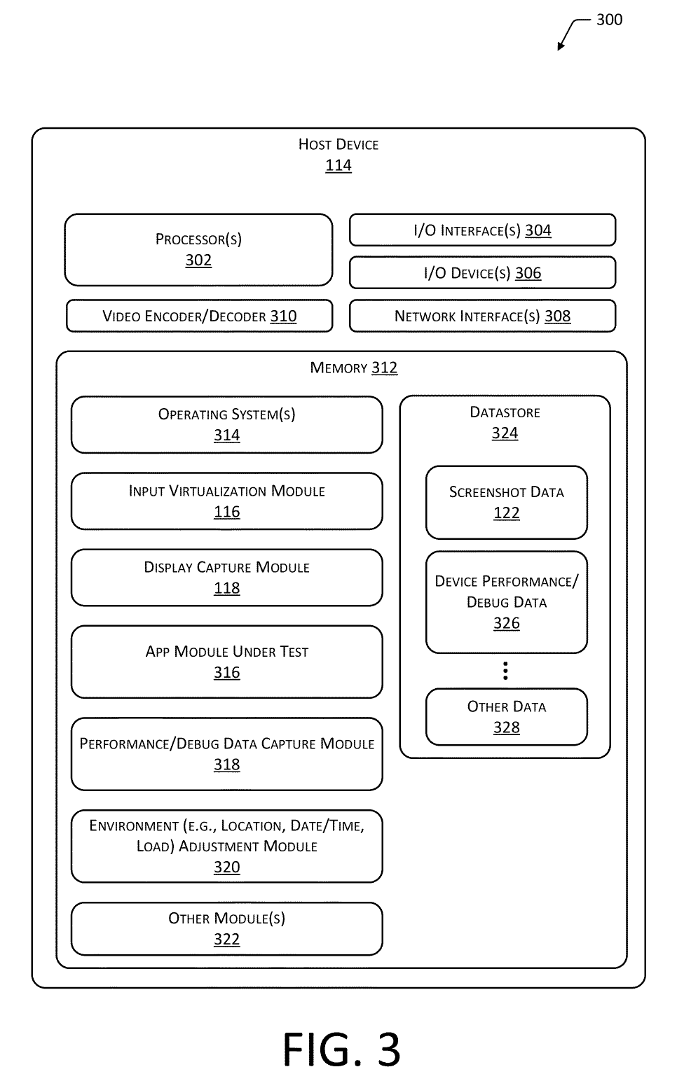

FIG. 3 depicts a block diagram 300 of the host device 114 that may be used to implement various embodiments described herein. The host device 114 may include one or more processors 302 configured to execute one or more stored instructions. The processors 302 may comprise one or more cores.

Similar to the remote control server 108, the host device 114 may include one or more input/output (I/O) interface(s) 304 to allow the host device 114 to communicate with other devices. The I/O interface 304 may be configured to provide a universal serial bus (USB) connection.

The I/O interface 304 may couple to one or more I/O devices 306. The I/O devices 306 may include user input devices such as one or more of a keyboard, a mouse, a pen, a game controller, a voice input device, a touch input device, gestural input device, the remote control server 108, and so forth. The I/O devices 306 may include output devices such as one or more of a display, a printer, audio speakers, haptic output device, and so forth. In some embodiments, the I/O devices 306 may be physically incorporated with the host device 114 or be externally placed.

The host device 114 may also include one or more network interfaces 308 configured to send and receive communications over the one or more networks 102. The host device 114 may also include one or more busses or other internal communications hardware or software that allow for the transfer of data between the various modules and components of host device 114.

The host device 114 may include a hardware-based video encoder/decoder 310. While a hardware-based video encoder/decoder is described, in some implementations a hardware-based video encoder may be used. The video encoder/decoder 310 may be incorporated into a common die the one or more processors 302 or may be on a separate die. The video encoder/decoder 310 may be configured to enable the capture of the screenshot data 122 in the H.264 or MPEG-4 Part 10 compliant format. The screenshot data 122 in this format may be assembled by the remote control server 108 into a high resolution (e.g., 1080 p, MPEG-4) video stream 124 as described herein for distribution to the client device 104.

As shown in FIG. 3, the host device 114 includes one or more memories 312. The memory 312 comprises one or more CRSM, as described above in FIG. 2. The memory 312 may include at least one operating system (OS) module 312. The operating system module 312 is configured to manage hardware resources such as the I/O interfaces 304 and provide various services to applications or modules executing on the one or more processors 302. The operating systems module 314 may comprise mobile operating systems configured for execution on mobile computing devices. The operating systems module 314 may implement one or more of iOS® from Apple Corp. of Cupertino, Calif.; Windows Mobile® from Microsoft Corp. of Redmond, Wash.; Android® from Google, Corp. of Mountain View, Calif. and its derivatives from various sources; Palm OS® from Palm Computing, Inc. of Sunnyvale, Calif. and its derivatives from various sources, BlackBerry OS® from Research In Motion Ltd. of Waterloo, Ontario, Canada; or other operating systems such as VxWorks from Wind River Systems of Alameda, Calif.

The memory 312 may include one or more of the input virtualization module 116, the display capture module 118, the app module under test 316, a performance/debug data capture module 318, or an environment adjustment module 320.

The input virtualization module 116 is configured to virtually execute input events, as described above in FIG. 1. These input events may be requested by the user 106 at the client device 104, generated automatically by the remote control server 108, or a combination thereof.

As also described above, the display capture module 118 is configured to capture screenshots of the host device 114 display and generate the screenshot data 122. The screenshot data 122 may be generated using the hardware-based video encoder/decoder 310. Use the hardware-based video encoder/decoder 310 allows for the high-fidelity capture and presentation of images presented on the display of the host device 114. This high-fidelity is based on the ability to capture the screenshots at the full resolution and at the full frame rate or redraw rate of the display.

The app module under test 316 is the application configured to run on the host device 114. For example, this may be the app which the user 106 has uploaded from the client device 104 to the remote control server 108 in order to test on the host device 114.

The performance/debug data capture module 318 is configured to capture one or more of performance data about the host device 114, code-level debug data for apps or other processes running on the host device 114, and so forth. The data may be provided to the client device 104 for presentation to the user 106.

The environment adjustment module 320 is configured to adjust the host device 114 environment based on input from the user 106 or a process of the remote control server 108. The environment includes OS, OS version, firmware, firmware version, language in use, date, time, location/position, orientation, and so forth.

The environment adjustment module 320 may modify the location of the host device 114 such that processes running on the host device 114 behave as though the host device were located in a location other than its actual, physical location. For example, the host device 114 may be located in a test facility in San Francisco, Calif., but the OS module 314 of the host device 114 or other applications may report a location of London, England.

The environment adjustment module 320 may also generate loads on the one or more processors 302, memory 312, I/O devices 306, or a combination thereof. For example, the environment adjustment module 318 may be configured to execute an application which consumes 50% of the processor 302 resources and uses enough memory 312 to result in a low-memory state in the OS. The app module under test 316 may then be executed, and tested under these loaded conditions. The user 106 may use the user interface on the client device 104 to remotely control the host device 114 in real-time to check for responsiveness, behavior, and so forth.

Other modules 322 may also be included in the host device 114. These other modules 322 may include, but are not limited to, other application modules not under test.

The memory 312 also includes a datastore 324 to store information for operations of host device 114. The datastore 324 may comprise a database, array, structured list, tree, or other data structure. The datastore 324 may store the screenshot data 122 generated by the display capture module 120. The screenshot data 122 may be stored until such data is retrieved from the host device 114 by remote control servers 108 or overwritten by the display capture module 118. Device performance and/or debug data 326 gathered by performance/debug data capture module 318 may also be stored. As above, the data 326 may be stored until retrieved by the remote control server(s) 108. Other data 328 may also be stored, such as user account information, network connectivity data, and so forth.

### Illustrative User Interface

FIG. 4 depicts an example user interface 400 for the remote control user interface module 218 of the remote control module 110. The interface 400 may comprise a web interface suitable for viewing within a web browser running on the client device 104 of the user 106. The interface 400 may include a device display 402 which provides the user with a real-time view of the display of the host device 114. In some embodiments, the device display 402 shows the video stream 124 generated based on high resolution screenshot data 122 of the display of the host device 114 as described above. Moreover, in some embodiments, the device display 402 is an interactive control that enables the user to specify input events to be virtually executed on the host device 114. For example, a mouse click or other gesture performed by the user within device display 402 may generate an input event for a touch input to be virtually executed at the corresponding location in the display of the host device. In some embodiments, device display 402 may also show various keys available on the host device 114, such that clicking within the host device display 402 in the area of the of the depicted key may generate a key input event to be virtually executed on the host device.

The interface 400 may also include a summary section 404, describing characteristics of the host device 114 or other aspects of the remote control test environment. For example, as shown in FIG. 4, summary section 404 may include information for a device type of the host device 114, an operating system and/or OS version for the OS running on the host device, one or more particular apps or other processes currently executing on the host device, a resolution of the video stream 124 currently being received from the remote control module 110, and so forth.

In some embodiments, the interface 400 may include one or more controls 406 to enable a user to select from a list of gestures or other input events to be virtually executed on the host device. In cases where the interface 400 is being viewed by the user 106 on the client device 104 that may not have input devices to perform certain types of gestures, the control 406 may enable the user to request such gestures be executed on the host device. For example, if the interface 400 is being viewed on a desktop or laptop computer without a touchscreen for complex, multi-part gestures (e.g., multi-finger pinching gestures) or without an input device to accept haptic inputs, the control 406 may enable the user to select such gestures or inputs. Embodiments may also provide for the input of custom gestures (e.g., user-defined gestures) through the web interface.

In some embodiments, the interface 400 may include a control 408 to enable a user to input a voice input event to be virtually executed on the host device 114. For example, control 408 may be a button to allow a user to toggle the acceptance of voice input, such that the user 106 may activate control 408 and speak into a microphone or other audio input of the client device 104. The recorded audio input may then be virtually executed as a voice input on the host device 114, e.g., to test audio input functionality of an app running on the host device.

In some embodiments, the interface 400 may include one or more interface elements to allow a user to specify environment setting(s) 402 to be set on the host device 114. For example, the interface 400 may include a control 410 to enable the user to set a location for the host device 114 and/or display the currently set location. The interface 400 may also include a control 412 to enable the user to set a date and/or time for the host device 114, and/or display the currently set date/time. The interface 400 may also include a control 414 to enable a user to specify a load to be placed on the host device 114, such as a processor usage load, and/or display the currently set load for the host device 114. Moreover, embodiments may enable the user 106 to launch one or more apps to test how a particular app (e.g., AppX) behaves when one or more other particular apps (e.g., AppY, AppZ, etc.) are executing on the same host device 114.

In some implementations the user 106 may be provided with the ability to change a memory state of the host device 114 through the control 414. Setting the memory state of the host device 114 may enable testing of an app's behavior under various memory conditions (e.g., when the local storage on the host device 114 is close to full or close to empty). For example, when the user 106 may wish to remotely test a camera-based app on the host device 114 generation of a user-specified number of pictures files to be stored in memory on the host device 114 may be provided to test the app under such memory conditions.

Although not shown in FIG. 4, embodiments may also provide the user 106 with the ability to change network conditions on the host device 114 for testing. For example, the user 106 may be allowed to set a wireless network strength or cellular telephone signal strength (e.g., one bar, two bars, three bars, and so forth) to test how an app behaves under various network conditions. By enabling the user to set various environment conditions on the host device 114, embodiments may enable the simulation of various real-world conditions for app testing on the host device 114.

In some embodiments the interface 400 may include a display 416 to provide to the user performance data for one or more performance metrics of the host device 114. For example, the display 416 may indicate the current processor or CPU usage on the host device 114, such as total usage or usage itemized for one or more executing processes on the host device 114. The display 416 may also show memory usage statistics for the host device 114, including total memory usage or memory usage itemized for one or more executing processes on the host device 114. The display 416 may also provide real-time log data, or other performance data. In some embodiments, the interface 400 may include a display 418 to provide code-level debug data for one or more apps or other processes currently executing on the host device 114. For example, such data may show a current location in source code for an executing app, current values stored in variables, current branches being executed, or other debug information. In some embodiments, display 418 may provide functionality to enable the user to set breakpoints in the code, step through the code line-by-line, stop or start execution, set values stored in variables, or perform other debugging tasks. Further, display 418 may also display stack dumps, identify particular line(s) of code that cause an error or exception, and/or provide other debug information when an app produces an error and/or uncaught exception.

In some embodiments the interface 400 may also include a control 420 to upload an app, program, or other file from the user's local client device 104 to the host device 114. For example, control 420 may open a “File Open” dialog to allow the user to identify a locally stored file to be uploaded to the host device 114. The control 420 may then cause the app to be installed on the host device 114 automatically, or may allow the user to remotely guide the installation through interaction with the host device 114 as described above.

Moreover, in addition to providing the video stream 124 as an output of the display from the host device 114, embodiments may provide other types of output from the host device 114. In some implementations audio output from the host device 114 may be captured, downloaded to the remote control server 108, and played back for the user 106 in real-time via the web interface on the client device 104.

Although FIG. 4 shows an example interface with various user interface elements in particular positions, the particular example arrangement shown is not in any way limiting of embodiments. Accordingly, various embodiments may employ a user interface that includes more or fewer user interface elements or controls, in any combination and in any arrangement to enable functionality of the embodiments. Further, embodiments may support multiple user interfaces (e.g., multi-page web sites) with functionality spread across various pages. Embodiments may also support dynamically generated interfaces, where the particular user interface elements displayed and the location and/or duration of their display is based on a particular state of the system, particular characteristics of the user and/or the local client device, or other factors.

### Illustrative Process

FIG. 5 depicts a flow diagram 500 of an example process 500 for remotely controlling the host device 114, according to embodiments described in this disclosure. As shown in FIG. 5, process 500 includes operations performed on the remote control server 108 and operations performed on the host device 114. In some embodiments, the operations performed on the remote control servers 108 may be performed at least in part by the remote control module 110 and/or its sub-modules, and the operations performed on the host device 114 may be performed at least in part by the input virtualization module 118, the display capture module 120, or a combination thereof.

In the example shown in FIG. 5, the remote control server 108 may receive environment settings 502, from the user 106 interacting through the web interface of the remote control module 110 as presented on the client device 104. At 504, on receiving the environment settings 502, the host device 114 may be instructed to set the host device environment according to the requested settings. In some embodiments, the environment settings may be transmitted to the host device 114, which implements the environment settings at 506. In some embodiments, such implementation may be performed by environment adjustment module 320 or another module of the host device 114. The environment settings 502 may include settings for device location, date, and/or time. The environment settings 502 may also include a user-requested load to be placed on the host device 114 processor or memory, e.g., to test how an app performs on the host device 114 under particular load conditions. For example, such a load request may cause a particular process to be launched on the host device 114, to generate the requested load on the host device 114's processor. The environment settings 502 may also include settings for network conditions on the host device 114, e.g. to set a strength of the available wireless data or telephone network accessible by the host device 114.

At 508, after receiving input events 120 specified by the user 106 through the web interface to the remote control module 110, the host device 114 may be instructed to perform the input events 120. At 510, the input events 120 may be executed on the host device 114 through virtualization. Embodiments support various types of input events, including but not limited to gestural inputs, touch inputs, voice or audio inputs, haptic inputs, key inputs, numeric inputs, or text inputs. In some cases, the client device 104 used by the user may include input devices corresponding to the desired input event. In such cases, the user 106 may input the input events using the corresponding input devices on the client device 104. For example, to request a touch input event to be performed on the host device 114, the user 106 may touch the touchpad of the local client device 104 in the corresponding manner.

In some cases, a user may be logged in to the web interface of the remote control module 110 from a client device 104 that does not have an input device corresponding to the desired input event. For example, the client device 104 may be a desktop computer lacking touch screen functionality. In such cases, the user 106 may employ the web interface of the remote control module 110 to specify text and numeric inputs by typing on a keyboard of the client device 104, and the user 106 may specify touch inputs by clicking a mouse button within the host device 114 display portion of the web interface 402. Moreover, the web interface may also include controls as described above with regard to FIG. 4 to allow the user 106 to specify haptic input events (e.g., shaking or rotating events) to be executed on the host device 114. The web interface may also include controls to allow the user to specify complex, custom, and/or multi-part gestures (e.g., a multi-finger pinching gesture to control zoom level on a display) to be executed on the host device 114, for situations where the user's local client device may not have the appropriate input device to accept such inputs.

In some embodiments, the input virtualization module 116 may be constantly executing as a background process on the host device 114, to virtually execute input events as they are received. Similarly, the display capture module 118 may also be constantly executing as a background process on the host device 114, to capture screenshots of the host device 114's display at regular intervals. As described above, these intervals may correspond to a refresh or redraw rate of the display, such as 60 screen shots per second.

For example, at 512 one or more screenshots are generated. In some embodiments, screenshots are captured using the hardware-based video encoder/decoder 310 of the host device 114 to capture screenshots in a high resolution format. The high resolution format may comprise imagery acquired at the frame rate or redraw rate of the display and at the display's native resolution. For example, the screenshot data 122 may be captured in the H.264 video format.

At 514, such screenshots are stored in local memory on the host device 114. In some embodiments, one screenshot is stored at a time, such that each screenshot overwrites the previous screenshot in the memory. The stored screenshots may be made available for retrieval by the remote control module 110, at a particular URL and port for the host device 114. In some embodiments, a USB 2.0 (or greater) connection is employed to download the screenshot data 122 at a high speed, to provide the user 106 with a real-time video stream 124 of the host device 114's display.

At 516, the remote control servers 108 may retrieve and store the screenshot data 122 (e.g., retrieving one screenshot at a time from the host device 114). At 518, the screenshot data 122 is assembled into a video stream 124. Because the screenshots are high resolution images, in some embodiments the assembled video stream 124 may be deemed a high resolution video stream 124. In some embodiments the assembled video stream 124 may be formatted as a MPEG-4 stream at 1920×1080 resolution and more than 50 frames per second.

In some embodiments, the video stream 124 provided to the user 106 may be adjusted based on the user's 106 available throughput of the network connection. In such cases, at 520 available throughput of the network connection to the user 106 is determined. At 522, the video stream 124 resolution is adjusted based on the detected available throughput of the connection. For example, if it is determined that the user's 106 connection available throughput has decreased, the video stream 124 may be downsampled to provide a lower resolution and/or lower quality video to the user 106. Similarly, if it is determined that the user's 106 available throughput has increased, the video stream 124 may be upsampled or otherwise adjusted to provide a higher resolution video. In this way, embodiments may provide a real-time video stream 124 to the user 106 to enable uninterrupted remote control of the host device 114.

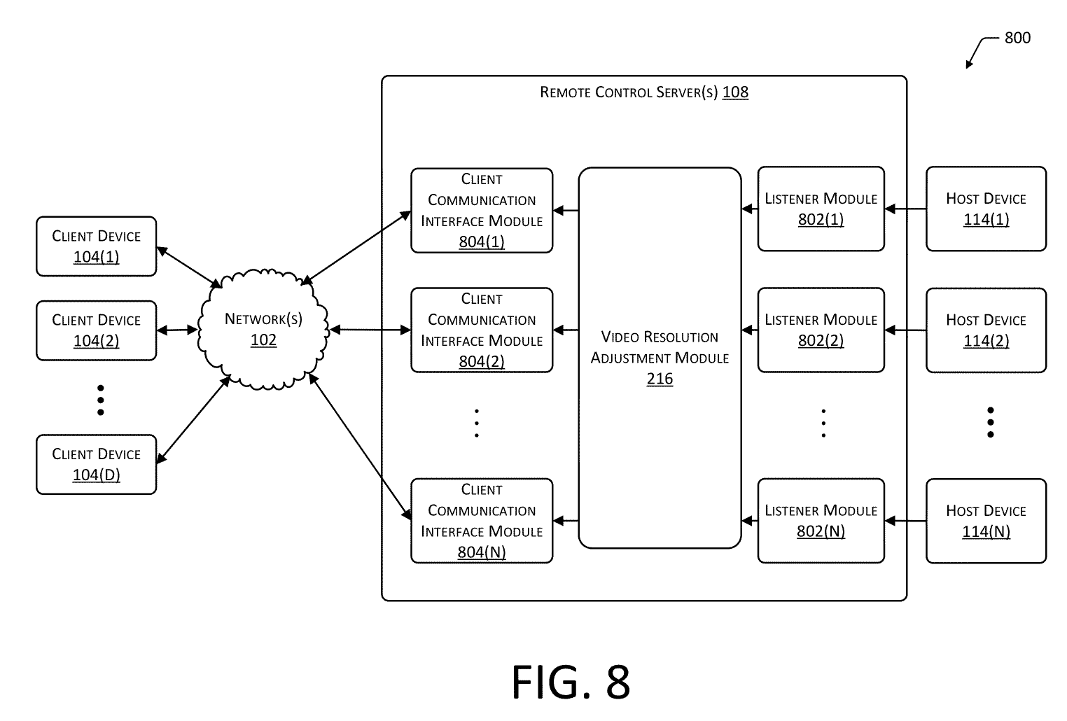

At 524, the video stream 124 (e.g., adjusted in some cases) is provided to the user 106 through the web interface of remote control module 110. In some embodiments, the one or more captured screenshots comprising the screenshot data 122 and/or the video stream 124 of the assembled screenshots are stored on the remote control server(s) 108. Such stored data may be provided to user 106 or another user and/or process, in response to a request for the data. The analysis and processing of the video data on the remote control server(s) 108 is described in further detail with reference to FIG. 8.

Although certain steps of process 500 are depicted as being performed serially, embodiments are not limited in this way. In some embodiments, one or more steps of process 500 may be performed continuously and/or simultaneously, e.g., as background processes. In some implementations execution of input events through virtualization (block 510), implementation of environment settings (block 506), and/or generation of screenshots (block 512) are performed by background processes running continuously on the host device 114. Thus, input events may be virtually executed on the host device 114 as they are received from the user 106 via the remote control servers 108. Further, screenshots may be captured as screenshot data 122 and stored on the host device 114 and retrieved by the remote control servers 108 at a predetermined frequency on an ongoing basis, to provide a video stream 124 of the host device 114's display to be provided to the user 106 on the client device 104.

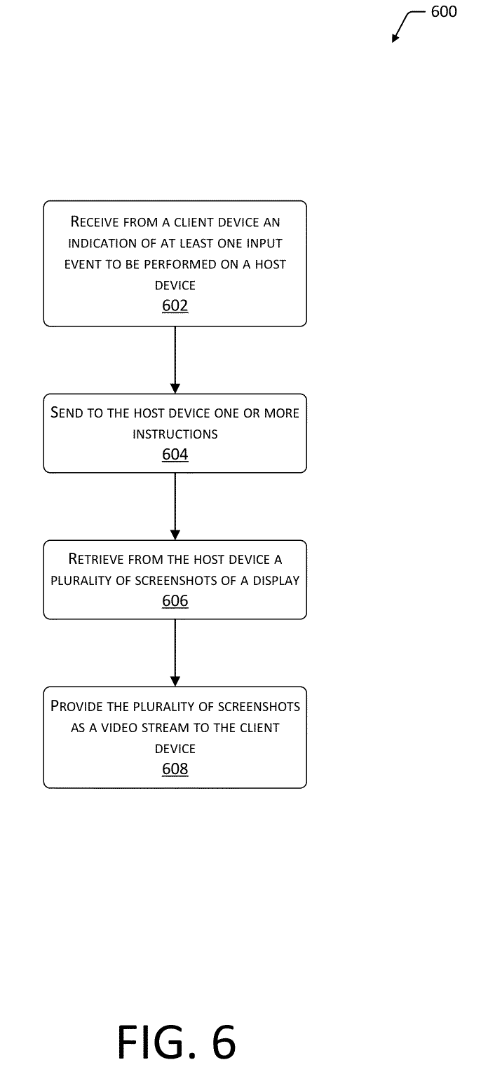

FIG. 6 depicts a flow diagram of a process 600 for providing input to the host device 114 and receiving the screenshot data 122 from the host device 114 for presentation on the client device 104 as the video stream 124. This process 600 may be implemented by the remote control server 108, the host device 114, the client device 106, or a combination thereof.

Block 602 receives, from the client device 104, an indication of at least one input event 120 to be performed on the host device 114. In some implementations at least a portion of the input events 120 may be received from or generated by the remote control server 108 or another device coupled to the remote control server 108. The input event 120 may include one or more of a gestural input, a touch input, an audio input, a haptic input, a key input, a numeric input, or a text input.

Block 604 sends, to the host device 114, one or more instructions to the input virtualization module 116 executing on the host device 114. The one or more instructions are configured to, when executed by the processor 302, perform the at least one input event 120 on the host device 114.

Block 606 retrieves, from the host device 114, a plurality of screenshots of one or more of the displays of the host device 114 generated as the host device 114 responds to the at least one input event 120. The plurality of screenshots may be processed at least partly by the hardware-based video encoder 310 on the host device 114.

Block 608 provides the plurality of screenshots as a video stream 124 to the client device 104. As described above, the video stream 124 may be a high-fidelity representation in high resolution of the images presented on the one or more displays of the host device 114.

In some implementations, additional blocks may be provided. A block may be configured to detect available throughput of the network connection to the client device 104. A subsequent block may adjust the resolution of the video stream 124 based at least in part on the detected available throughput of the network connection.

In some embodiments, the host device 114 may comprise a mobile computing device. The mobile computing device may be communicatively coupled using one or more electrical conductors or optical fibers to a communication interface coupled in turn to the device executing this process 600. For example, a USB 2.0 or better interface may be used to couple the host device 114 to the remote control server 108.

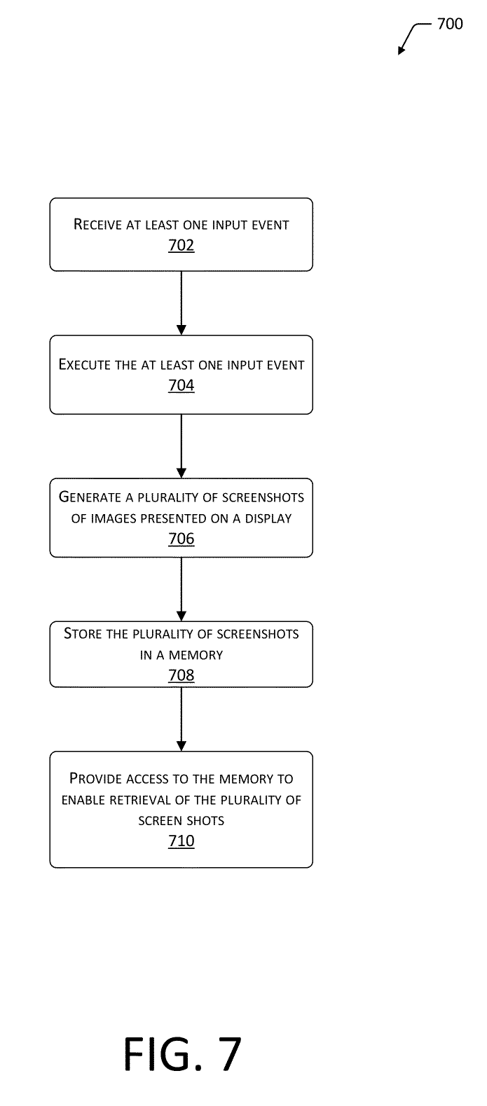

FIG. 7 depicts a flow diagram of a process 700 for remotely controlling the host device 114. This process 700 may be implemented by the host device 114, the remote control server 108, the client device 106, or a combination thereof.

Block 702 receives at least one input event 120. For example, the remote control server 108 may accept input from the user 106 via the user interface presented on the client device 104, and provide the accepted input to the host device 114.

The application module under test 316 or another application module may be executed by the processor 302. The at least one input event 120 may be provided by the user 106 using the client device 104 to remotely control the at least one application via the remote control server 108 and the input virtualization module 116 and the display capture module 118.

Block 704 executes the at least one input event 120. In some implementations, the processor 302 may execute the input virtualization module 116 to provide the functionality of blocks 702 and 704.

Block 706 generates the screenshot data 122 comprising a plurality of screenshots of images presented on the display of the host device 114. As described above, the plurality of screenshots may be processed or generated at least in part by the hardware-based video encoder/decoder 310 to produce the screenshot data 122.

The screenshots may be generated at a refresh rate and resolution of the display. For example, where the display has a refresh rate of 60 frames per second and resolution of 1920×1080 pixels, the screenshots may be generated sixty times per second and at the resolution of 1920×1080. Other frame rates and resolutions which correspond to the operation of the one or more displays may be used as well. For example, the plurality of screenshots may be encoded at a frame rate of at least fifty frames per second and a resolution of at least 1280 by 720 pixels. Furthermore, the screenshot data 122 may be encoded in a Motion Picture Experts Group (MPEG)-4-compliant format.

The plurality of screenshots may be stored serially and individually in the memory 312. Each screenshot may overwrite a preceding screenshot in the memory 312. In another implementation, each screenshot may be erased after retrieval, such that overwriting is not necessary.

Block 708 stores the plurality of screenshots in the memory 312. Block 710 provides access to the memory 312 to enable retrieval of the plurality of screenshots by an external device. For example, the remote control server 108 may retrieve the screenshot data 122 using the USB interface of the I/O interface 304. The display capture module 118 may provide the functionality of blocks 706 and 708.

In some implementations, other blocks may provide additional functions. For example, blocks may collect debug information associated with the execution of app module under test 316 or of other instructions executing on the processor 302. A subsequent block may provide the debug information to the remote control server 108. In one implementation the debug information may be stored in the memory 312 for retrieval by the remote control server 108.

FIG. 8 depicts an environment 800 in which remote control of one or more host devices 114 is provided. As shown, environment 800 may include one or more client devices 104(1)-104(D) employed by users 106 to remotely control one or more host devices 114(1)-114(N). Such client devices 104 may communicate over the network(s) 102 (e.g., the Internet) with the remote control server(s) 108. In some implementations, the remote control server(s) 108 execute one or more listener modules 802(1)-802(N). Each listener module 802 may monitor an incoming stream of screenshot data 122 from one of the host devices 114. The remote control server(s) 108 may also execute one or more client communications interface modules 804(1)-804(N), each mediating communications with one or more of the client devices 104(1)-(D). As used in this disclosure, letters in parenthesis such as “(D)” or “(N)” indicate a non-zero positive integer.

In some implementations, each listener module 802 is a communication interface module executing on the one or more processors 202. The listener module 802 monitors wired or wireless communications from a respective host device 114, listening for video data available for retrieval from the host device 114. In some implementations, communication between a listener module 802 and a host device 114 is over a USB line, compliant with USB 2.0 or higher. In some implementations, the communication interface is configured to support at least a minimum bandwidth for communications to the host device, sufficient to handle 1080 p or higher screenshots sent at the sampling frequency of the display capture module 118 (e.g., 30-60 frames/second).

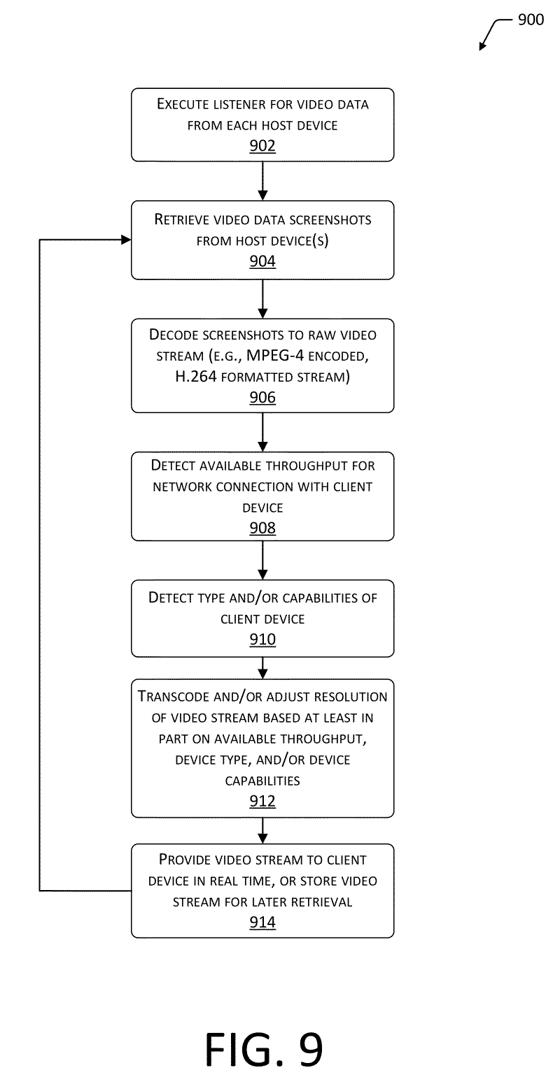

A module of the remote control server(s) 108, such as the video resolution adjustment module 216, may receive the incoming video data from each listener 802. In some implementations the module 216 may adjust resolution and/or transcode each incoming stream of screenshot data 122, then provide a resulting video stream 124 to a respective client device 104 through the client communications interface module 804. The resolution adjustment and/or transcoding operations of the video resolution adjustment module 216 are described further with regard to FIG. 9.

FIG. 9 depicts a flow diagram of a process 900 for adjusting the video data received from the host device 114. This process 900 may be implemented by the host device 114, the remote control server 108, the client device 106, or a combination thereof. At 902, a listener module 802 may be executed for each of or more host devices 114, each listener module 802 listening for video data from its respective host device. At 904, video data (e.g., screenshots) is received from the host device(s) 114. In some implementations, video data is received from a plurality of host devices 114 over a USB port configured to support USB 2.0 or higher, and the plurality of listener modules 802 each listen at the same port. As described above, the video data incoming from each host device 114 may be 1080 p video.

At 906, the incoming screenshot data 122 from each host device 114 is decoded to generate an initial video stream. In some implementations, the initial video stream is a MPEG-4/H.264 formatted, high-resolution stream. At 908, available throughput is detected for a network connection between each client device 104 and the client communications interface module 804. In some implementations, the available throughput or other network condition metric is polled at a predetermined frequency, e.g., once every n number of frames received from the corresponding host device 114.

In some implementations, at 910 a type and/or capabilities of the client device 104 are detected. For example, where communications between the remote control server(s) 108 and client devices 104 are via a networking protocol that includes a device type or device identifier in packet data, the device type may be determined by examining packet data. In some cases, the client device 104 may be polled to determine a device type and/or capabilities. Having determined the device type, some implementations may determine capabilities of the client device 104 based on its type. Such capabilities may include a native resolution of a display associated with the client device. In some implementations, the client device 104 may be polled to determine its display capabilities.

At 912, the initial video stream may be transcoded from its initial format (e.g., MPEG-4) to a different output format (e.g., MPEG-2). Also, at 912 the resolution of the initial video stream may be adjusted from its initial resolution (e.g., 1080 p) to a different output resolution (e.g., 720 p). Such transcoding and/or resolution adjustment may be based on the detected available throughput of the network connection, device type, and or device capabilities of the client device 104 to receive the video stream 124. For example, responsive to the device capabilities of a client device 104 with a 720 p display, the output resolution of the video stream 124 may be configured to 720 p even when the screenshot data 122 comprises high resolution data.

At 914, the adjusted and/or transcode video stream is provided to the client device 104 in real time. In some cases, the video stream 124 may be stored and provided to the client device 104, another device, or another process later in response to a request for the video stream 124. Monitoring of the available throughput or other network conditions may proceed on an ongoing basis, and the resolution and/or encoding of the video stream may be adjusted based on changes in the detected connection speed. For example, the video stream 124 may be downsampled on detecting a decrease in the available throughput, and upsampled on detecting an increase in the available throughput. Thus, implementations may provide for smooth, live playback of video of the host device's 104 display to the user 106 for remote control.

### CONCLUSION

Those having ordinary skill in the art will readily recognize that certain steps or operations illustrated in in the figures above can be eliminated, combined, subdivided, executed in parallel, or taken in an alternate order. Moreover, the methods described above may be implemented as one or more software programs for a computer system and are encoded in a computer-readable storage medium as instructions executable on one or more processors.

Separate instances of these programs can be executed on or distributed across separate computer systems. Thus, although certain steps have been described as being performed by certain devices, software programs, processes, or entities, this need not be the case and a variety of alternative implementations will be understood by those having ordinary skill in the art.

Additionally, those having ordinary skill in the art skill readily recognize that the techniques described above can be utilized in a variety of devices, environments, and situations. For example, although the examples above describe a user interacting with a web interface to remotely control a device, embodiments also provide for a script, program, or other automated process to drive the remote control of the host device 114. For example, embodiments support the utilization of HTTPUnit or other automation software to enable scripts to drive the web interface for remote control of the host device 114, e.g., for automated app testing. Although the present disclosure is written with respect to a specific embodiments and implementations, various changes and modifications may be suggested to one skilled in the art and it is intended that the present disclosure encompass such changes and modifications that fall within the scope of the appended claims.

1. One or more non-transitory computer-readable media storing computer-executable instructions that, when executed by at least one processor of a client device, instruct the client device to perform operations comprising:
specifying, by a user interface of the client device, at least one input event to be performed on a host device, wherein the user interface comprises an interactive control and a selection control, wherein the interactive control is configured to receive a first particular input at the client device and generate a first input event corresponding to the first particular input, and wherein the selection control is configured to allow selection of a particular input event from a list of input events and generate a second input event corresponding to the selected particular input event, wherein the client device is not configured to receive a multi-part gesture as an input, and wherein the list of input events comprises an input event corresponding to the multi-part gesture;
providing, by the client device, one or more instructions to the host device, wherein the one or more instructions perform at least the first input event and the second input event on the host device;
receiving, at the client device, a plurality of screenshots of a display of the host device generated in response to at least the first input event and the second input event; and
providing the plurality of screenshots using the user interface of the client device.

2. The non-transitory computer-readable media of claim 1, the operations further comprising:
detecting available throughput of a network connection to the client device; and
adjusting a resolution of a video stream based at least in part on the detected available throughput of the network connection, wherein the video stream comprises the plurality of screenshots.

3. The non-transitory computer-readable media of claim 1, wherein the at least one input event includes an input event for at least one of a gestural input, a touch input, an audio input, a haptic input, a key input, a numeric input, and a text input.

4. The non-transitory computer-readable media of claim 1, wherein the user interface comprises a device display, configured to display the plurality of screenshots, and wherein the interactive control is configured to receive the first particular input from within the device display.

5. The non-transitory computer-readable media of claim 1, further comprising:
setting one or more conditions for a communications network via the user interface, wherein the one or more conditions comprise a signal strength of the communications network.

6. The non-transitory computer-readable media of claim 1,
wherein providing the plurality of screenshots using the user interface of the client device comprises:
assembling the plurality of screenshots into a video stream; and
providing the video stream using the user interface of the client device.

7. The non-transitory computer-readable media of claim 6, the operations further comprising:
downsampling the video stream prior to providing the video stream to the client device, based on at least one of a device type, a device capability, or a network connection speed for the client device.

8. A system comprising:
at least one memory;
at least one processor configured to access the at least one memory; and
a remote control module, stored in the at least one memory and executed by the at least one processor, the remote control module comprising:
a user interface configured to specify at least one input event, the user interface module comprising:
a device display, configured to display a plurality of screenshots generated in response to the at least one input event,
an interactive control, configured to receive a first particular input within the device display and generate a first input event corresponding to the first particular input, and
a selection control, configured to allow selection of a particular input event from a list of input events and generate a second input event corresponding to the selected particular input event, wherein the user interface is not configured to receive a multi-part gesture as an input, and wherein the list of input events comprises an input event related to the multi-part gesture;
wherein the remote module is configured to:
provide one or more instructions to perform at least the first input event and the second input event to a host device;
receive a plurality of screenshots of a display of the host device, the plurality of screenshots generated in response to at least the first input event and the second input event; and
provide the plurality of screenshots using the user interface.

9. The system of claim 8, wherein the plurality of screenshots are generated at a pre-determined refresh rate and a pre-determined resolution.

10. The system of claim 8, where in the plurality of screenshots are encoded in a pre-determined video coding format.

11. The system of claim 8, wherein the plurality of screenshots are stored such that a second screenshot overwrites a first screenshot, and wherein the first screenshot precedes the second screenshot.

12. The system of claim 8, wherein the at least one input event is provided to remotely control at least one application.

13. A method, comprising:
specifying, by a user interface of a client device, at least one input event, wherein the user interface comprises an interactive control and a selection control, wherein the interactive control is configured to receive a first particular input at the client device and generate a first input event corresponding to the first particular input, and wherein the selection control is configured to allow selection of a particular input event from a list of input events and generate a second input event corresponding to the selected particular input event, wherein the client device is not configured to receive a multi-part gesture as an input, and wherein the list of input events comprises an input event related to the multi-part gesture;
providing, by the client device, one or more instructions to perform at least the first input event and the second input event on a host device;
receiving, at the client device, a plurality of images of display of the host device, wherein the plurality of images were generated in response to at least the first input event and the second input event; and
providing the plurality of images using the user interface of the client device.

14. The method of claim 13, further comprising:
detecting available throughput of a network connection to the client device; and
adjusting a resolution of a video stream based at least in part on the detected available throughput of the network connection, wherein the video stream comprises
the plurality of images.

15. The method of claim 13, wherein the at least one input event includes an input event for at least one of a gestural input, a touch input, an audio input, a haptic input, a key input, a numeric input, and a text input.

16. The method of claim 13,
wherein the user interface comprises a device display, configured to display the plurality of screenshots, and wherein the interactive control is configured to receive the first particular input from within the device display.

17. The method of claim 13, further comprising:
setting one or more conditions for a communications network via the user interface, wherein the one or more conditions comprise a signal strength of the communications network.

18. The method of claim 13, wherein providing the plurality of screenshots using the user interface of the client device comprises:
assembling the plurality of the images into a video stream
providing the video stream using the user interface of the client device.

19. The method of claim 13, the operations further comprising:
receiving debug information associated with the execution of the one or more instructions to perform at least the first input event and the second input event; and
providing the debug information using the user interface of the client device.

20. The method of claim 13, wherein the user interface is configured to enable performing one or more tasks related to debugging a software application.
